(19) United States
(12) Patent Application Publication
(10) Pub. No.: US 2004/0079932 A1
(43) Pub. Date: Apr. 29, 2004

(54) Shock-absorbing guardrail device

(76) Inventors: Isao Hanai, Aichi (JP); Mikio Hanai, Aichi (JP); Makoto Hanai, Aichi (JP)

Correspondence Address: Jeffrey D. Washville, LORUSSO LOUD & KELLY LLP, 440 Commercial Street, Boston, MA, 02109, US

(21) Appl. No.: 10/690,187

(22) Filed: Oct. 21, 2003

Related U.S. Application Data
(63) Continuation-in-part of application No. 10/664,266, filed on Sep. 17, 2003.

(30) Foreign Application Priority Data
Sep. 9, 2002 (JP) 2002-262311
Mar. 26, 2003 (JP) 2003-84232

(51) Int. Cl. A01K 3/00

(52) U.S. Cl. 256/13.1

(57) ABSTRACT

A shock-absorbing guardrail that is easy to install and remove that prevents a support post from collapsing by absorbing the shock caused by a car collision thus reducing repair time. The shock-absorbing device is attached to the guard fence between the structure or support post. A mid-filler attachment may have an ohm-shaped cross-section or vertically opened pipe-shaped cross-section. The guard fence and mid-filler attachment may be attached to the support post or structure with removable connectors for faster installation and removal. The shock-absorbing device is designed to absorb collision energy by irreversible deformation of the mid-filler attachment.

### CROSS REFERENCE TO RELATED APPLICATIONS

This application claims a benefit of priority to Japanese Application No. 2002-262311 filed on Sep. 9, 2002, now abandoned, and Japanese Application No. 2003-84232 filed on Mar. 26, 2003, currently pending, and a continuation-in part of U.S. application Ser. No. 10/664,266 filed Sep. 17, 2003, currently pending, the contents of these applications are incorporated by reference in their entirety.

### BACKGROUND OF THE INVENTION

Guardrails are installed along roadsides in order to prevent cars from jumping into oncoming lanes, sidewalks and rolling down steep embankments. Collision with a guardrail normally occurs when a driver looses control of a vehicle through inattention, poor road conditions or collision with another vehicle.

One type of guardrail generally consists of a long sheet fence, a support post, and a rigid mid-filler attachment connected between the first two components. Such a guardrail can be made more rigid only by narrowing the span of the support posts. This type of guardrail absorbs collision energy mainly by deformation of the fence or support post.

Japanese Patent No. 6-280222 modifies an ordinary guardrail to include a modified support post with an elastically recoverable elastic body. Japanese Patent No. 7-150529 discloses a guardrail having a housing with several pipes connected into the cushion cover and that covers the support post. Japanese Patent No. 10-18257 discloses a guardrail made with components having different rigidities, a rigid face to end portion and a relatively brittle face to others.

### SUMMARY OF THE INVENTION

The invention is a shock-absorbing device for use in a guardrail that can be situated, for example, at a median or parapet of a bridge. This device absorbs the shock of a car collision and prevents components of the guardrail, such as support posts and parapets of a bridge, from collapsing.

One type of guardrail that can reduce the shock of impact transmitted to its support post by reduces the speed of a colliding car by absorbing shock via deformation of the rail or collapse of its support post. Using more support posts increases the rigidity of the guardrail's entire structure, but the support posts do not have the capability of absorbing much shock.

If more support posts are to be employed, however, extra area for the collapse of the support post is required to allow for an appropriate guardrail area. Failure to provide this area may endanger cars driving on the opposite side of the roadway or pedestrians walking on the outside of the guardrail.

If the collision energy is excessive, collapse of the support post may increase the possibility of the colliding car bursting through the guardrail and causing further damage to property and/or individuals. If the guardrail collapses, the colliding car may exit the travel lane making it difficult to bring the car safely back into the travel lane.

When repairing a bent support post by bending it in an opposite direction of the bend to bring it back to a vertical position often results in a break at the bend. Metal fatigue is often the cause. This necessitates replacement of the damaged foundation and the need to mount a new support post, which is inconvenient and costly when combined with replacement of any breakage in the guardrail. If the damaged support post is left in a state of disrepair, it can become an obstacle for the passage of vehicles and pedestrians.

One way these problems are addressed is by increasing the rigidity of the support post to reduce the amount of deformation. The rigid guardrail, however, loses the capability of absorbing enough collision energy and allows the transmission of collision shock. This reduces the safety of the occupants of car that collides with the rigid guardrail.

When the support post has an elastically recoverable elastic body, it has the ability to absorb shock by reducing the speed of a colliding car before it collides into the support post. The elastically recoverable body, however, may cause severe secondary injuries and damage due to the elastic restoring force that can transmit elastic force to the occupants of the colliding car after the car has come to a stop.

The present invention solves the above-mentioned problems by providing a shock-absorbing guardrail device that has a simple structure. The structure can prevent the support post from collapsing by absorbing the shock caused by the collision of a car.

A further goal is to reduce the necessity of repairing damaged foundations and the need for new support posts during reconstruction of the guardrail. This invention utilizes a mid-filler attachment that undergoes an irreversible deformation during collision. The attachment has either an ohm-shaped cross-section or a vertically-opened, pipe-shaped cross section attached to a support post or structure. The guard fence attaches to and bridges each support post by connection parts to absorb colliding energy of a car, which overcomes the problems mentioned above.

In one embodiment, irreversible deformation of the mid-filler attachment with either the ohm-shaped cross section or the vertically-opened, pipe-figured cross-section and is utilized and connected to a construct. The back of the guard fence faces and is attached to, the surface of the construct by connection parts and absorbs the collision energy of the car, which overcomes the above-mentioned problems.

A further embodiment utilizes a shock-absorbing pipe or shock-absorbing resin along with the shock-absorbing elements mentioned above.

Another embodiment involves attaching the shock-absorbing guardrail device, discussed above, onto a construct located at a hydrant, a semaphoric pole, a bifurcation (diverging point), an anti-collision section, and a sectional wall.

A further embodiment utilizes a mid-filler attachment characterized by its cross section comprising a layered, laminated, or stratified ohm figure in place of the mid-filler attachment or pipe discussed above.

The above-described shock-absorbing guardrail device can absorb collision energy of a car by an irreversible deformation of a mid-filler attachment and deformation of the guardrail itself. The deformation absorbs the impact of the collision transmitted to the support post by reducing the speed of a colliding car.

The shock-absorbing guardrail device does not employ an elastic body and prevents transmission of elastic force to the occupants of a colliding car when stopped. The shock-absorbing guardrail device will not cause secondary injury or damage caused by the elastic restoring force as is common with guardrails having elastic bodies.

The shock-absorbing guardrail device has a simple structure that is easy to install and remove, even after an impact by a vehicle. The device has the capability of preventing the support post from collapsing by absorbing shock through the deformation of a collision energy absorbing pipe or mid-filler attachment. The substantial absorption of crash energy reduces the necessity of repairing damaged post foundations and setting up new support posts during repairs, which therefore reduces costs.

When an excessive load is applied to the guardrail as with a high speed collision or collision with a vehicle having excessive weight, the collision energy can be absorbed by deformation or collapse of the support posts that enables the car to safely return to the travel lane so as to secure the safety of the cars occupants.

This shock-absorbing device can be installed on hydrants, semaphoric poles, bifurcations (diverging point), column-shaped safety drums located at bifurcations, anti-collision sections in front of toll booths, and sectional building blocks (i.e. walls at parking lots, concrete walls) and so on. The shock-absorbing device can be attached to those structures and provide the same benefit as explained above by covering the surface of the structure either partially or fully with the device.

### BRIEF DESCRIPTION OF THE FIGURES

FIG. 1(a) shows side view of one embodiment shock-absorbing device. (Guard fence is shown as shape of cross section.)

FIG. 1(b) is a cross-sectional view of the main portion of the shock-absorbing device.

FIG. 2 is a cross-sectional view showing one embodiment of the shock-absorbing device in a squashed condition after a collision.

FIG. 3 is a cross-sectional view of one embodiment of the shock-absorbing device.

FIG. 4 is a cross-sectional view of a main part of another embodiment of the shock-absorbing device.

FIG. 5 is a cross-sectional view of a main part of a mid-filler attachment embodiment.

FIG. 6 is a graph showing the results of static experimentation of one embodiment of the shock-absorbing device wherein the horizontal axis represents change in vertical size (mm), and the vertical axis represents a load (kg) placed on a top surface.

FIG. 7(a) is a side view of an ordinary guardrail. The guard fence is shown in cross section.

FIG. 7(b) shows a cross-sectional view of a main part of an ordinary guardrail.

### DETAILED DESCRIPTION OF THE INVENTION

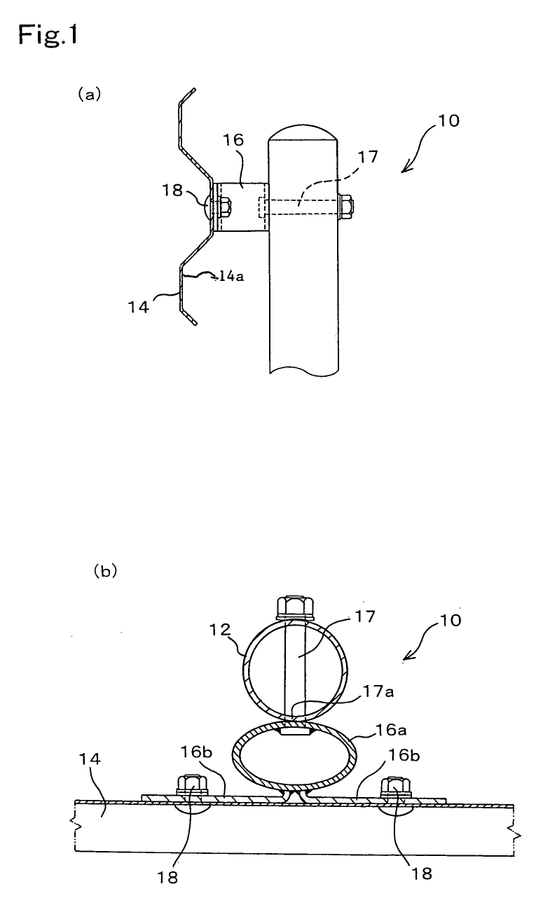

FIG. 1(a) is a side view of one possible embodiment of the shock-absorbing device shown generally as 10. A guard fence 14 is shown in cross section. FIG. 1(b) is a cross-sectional view of the main portion of the shock-absorbing device 10.

Shock-absorbing device 10 comprises support post 12 that is erected parallel to the roadside with certain span. A back surface 14a of guard fence 14 back 14a is attached to support post 12 and bridges each support post 12. A mid-filler attachment 16 is installed in-between each support post 12 and guard fence 14 and acts as a connecting element between them. Connector 17, which can be a bolt, rivet, screw or other equivalent fastener, connects support post 12 and mid-filler attachment 16. When connector 17 is a bolt or other releasable type of equipment, it allows for faster repair and installation. Guard fence connector 18 attaches guard fence 14 to mid-filler attachment 16.

As shown in FIG. 1(b), an elliptical Mid-filler attachment 16a conforms to the shape of an ellipse.

Support post 12 can be a rust proofed steel product or other material having equivalent properties of strength and is affixed on the roadside by mounting a lower portion into a foundation such as concrete. The support post 12 may also be attached at its lower portion to the foundation via bolting or other means of attachment.

In one potential embodiment, a through-Hole 17 is placed at an upper part of the support post 12 so that connector 17 can perforate support post 12 and connect support post 12 and mid-filler attachment 16. Other means of mounting the mid filler attachment 16 to the support post 12 (not shown) can be accomplished without the perforation of support post 12 by the use of a U-bolt passing around the body of the post 12 or the use of a cap containing a perforation and connector 17 that could be mounted over the top of the support post 12 by such method as a friction fit to perform the identical function of attaching the mid-filler attachment 16 to the support post 12. It should be understood that many other means of fastening the mid-filler attachment 16 to the support post 12 can also be envisioned by one skilled in the art to provide similar function.

Guard fence 14 may be a rust proofed steel product or a material having similar properties, having a flat or a contoured deck plate as displayed in FIG. 1(a). One method of attaching guard fence 14 is by the placement of a through-hole 18 to receive fence connection parts 18 in order to affix mid-filler attachment 16. Conversely, fence connector parts 18 could be welded or affixed to guard fence 14 so that a through-hole 18 could be omitted if desired. There are many possible methods of attaching guard fence 14 to incorporate the mid-filler attachment 16 between the support posts 12.

In FIG. 3, the Mid-filler attachment 16 comprises a collision energy absorbing pipe 16a (having a closed elliptical cross section that changes shape with irreversible deformation) and arm parts 16b (which may be welded or otherwise affixed to the guard fence 14 side). A through-hole 19 may be placed on each of the arm parts 16b at corresponding positions of through-Hole 18a.

It should be understood and appreciated that the one possible embodiment described and explained above, is by way of illustration and not limitation. There are other obvious design changes that can be employed to accomplish the same ends.

FIG. 3 shows another embodiment of installing a collision energy absorbing pipe 16a between the support post 12 and guard fence 14. These elements are connected directly by connection parts 17 and connection parts 18. (This is designated as shock-absorbing device 10′)

The material, size, and shape of the support post 12, guard fence 14, and mid-filler attachment 16 can be modified to direct a car that has collided with the guardrail to be brought safely back to the travel lane. The optimization of the cushioning performance influenced by the type of car, its speed at collision, its weight, angle of impact, etc.

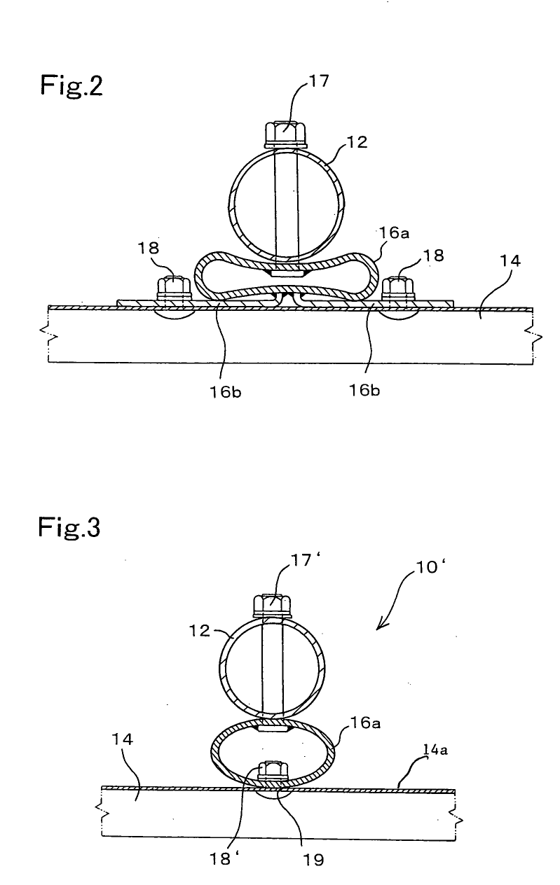

When a car collides into a guardrail, made in accordance with the invention, it absorbs the energy of the moving car and irreversibly deforms the collision energy absorbing pipe 16a. The absorption of energy results in a reduction of the speed of the colliding car. (See FIG. 2) Absorbing collision energy through deformation of the collision energy absorbing pipe 16a reduces the likelihood of the support post 12 being bent. The remaining collision energy that is transmitted to support post 12 after deformation of the collision energy absorbing pipe 16a reduces the possibility of collapsing the support post 12 during impact. The prevention of damage to the support post 12 will prevent the need for replacing the support post 12 or fixing damaged foundations thereby reducing the costs of maintaining and repairing the guardrail.

When an excessive load is applied such as that which occurs when a vehicle with excessive speed or excessive weight collides with the guardrail, the excess collision energy can be absorbed by deformation or collapse of the support posts 12.

It should be understood that if the rigidity of the mid-filler attachment is either too small or too large, it cannot absorb the energy of the colliding car in some circumstances. This may reduce the safety of the occupants of the vehicle.

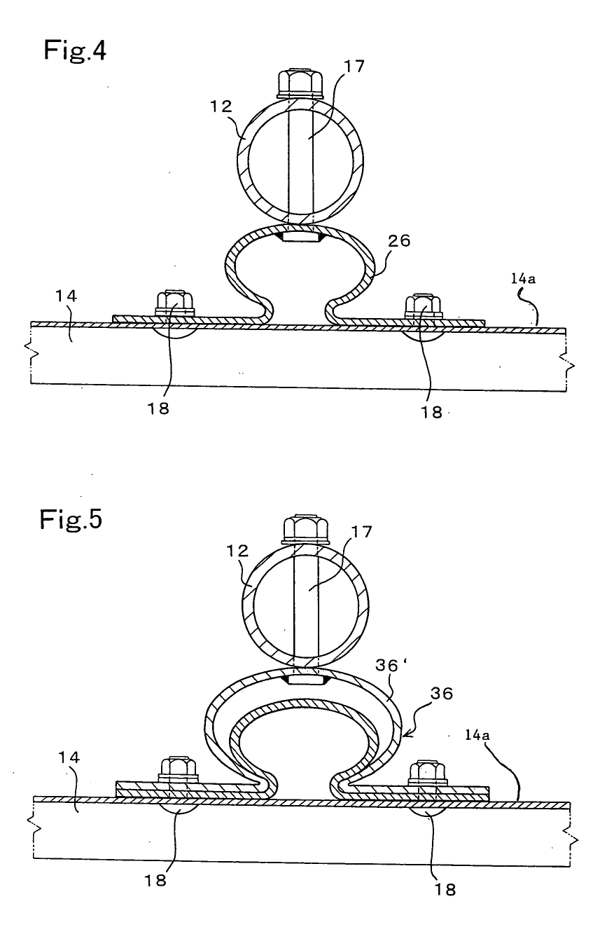

FIG. 4 shows a cross-sectional view of a main portion for a shock-absorbing device 20. Shock-absorbing device 20 is similar to shock-absorbing device 10 except that the mid-filler attachment 26 has an ohm-shaped cross-section that is comprised of an integrated combination of a collision energy absorbing pipe 16a and arm parts 16b. The mid-filler attachment 26 may optionally contain the mid-filler attachment 16a either within the center of the hollow of the mid-filler attachment 26 between the guard fence 14 and the mid-filler attachment 26 or positioned between the support post 12 or structure and the outside top of the mid-filler attachment 26. Furthermore, the above combinations can include a shock absorbing resin within any hollow section between the back of the guard fence 14 and the support post 12 or structure.

The mid filler attachment 26 having the ohm-shaped cross-section has a body that is a portion of a radius of a circle or an ellipse that transitions into at least one integrated arm. The arm has an angle of about 5 to 90 degrees to that of the body. The mid-filler attachment 26 with a short length can be oriented in any direction and at least one of the integral arms is attached to the back of the guard fence 14. The mid-filler attachment 26 can have a length similar to the diameter of the support post 12 or be oriented so that it can span the entire length of any portion thereof of the guard fence 14.

Optionally the ohm-shaped mid-filler attachment 26 can have a means for propagating crash energy along the length of the ohm-shaped mid-filler attachment by providing a thicker area along the length of the mid-filler attachment that intersects with the point of attachment of the mid-filler attachment 26 to either the support post 12 or structure (not shown).

FIG. 5 shows a cross-sectional view of a shock-absorbing device 30 having at least two of the ohm-shaped mid-filler members comprising a large mid-filler member 36 and a small mid-filler member 26. The small mid-filler member 26 can be arranged or positioned within the large mid-filler member 36.

Materials, sizes, and shapes of ohm-shaped mid-filler attachments 26 and mid-filler attachments 36 can be changed to maximize the ability to bring a car safely back to the travel lane. The mid-filler attachment can be optimized for cushioning performance according to the kind of car, its speed at collision, its weight, etc.

Optionally, a shock-absorbing resin can be employed and installed within the collision energy absorbing pipe 16, or the U-shaped portion of mid-filler attachment 26 or within the back portion of the guardrail 14. The structure can be designed so that only the shock-absorbing resin changes shape or both the shock-absorbing resin and collision energy absorbing pipe or U shape portion of mid-filler attachment change shape. (No Figure shown).

This shock-absorbing device can be installed not only in the space between the support post 12 erected in line with the ground and guard fence and bridging several support posts, but also on hydrants, semaphoric poles, bifurcations (diverging point), column-shaped safety drums located at bifurcations, anti-collision sections in front of toll booths, and sectional building blocks such as walls at parking lots, concrete walls and so on. The shock-absorbing device can be attached to these structures and provide the same benefits as explained above by covering the surface either partially or fully with it.

Static experimentation was carried out to determine the static performance of the mid-filler attachment. Two kinds of mid-filler attachments were tested, a mid-filler attachment 26 (made of SS400 steel [Height: 50 mm], made by folding a plate having a thickness: 4.5 mm, and Width: 50 mm] into an ohm shape) and a mid-filler attachment 36 (made of SS400 steel [Height: 100 mm], made by folding a plate [Thickness: 4.5 mm, and Width: 50 mm] into an ohm shape) outside and a mid-filler attachment 26 inside. The attachments were examined by setting each attachment onto a base plate and applying a load (kg) from above. The relationship between load and the change in vertical size (mm) was monitored and measured.

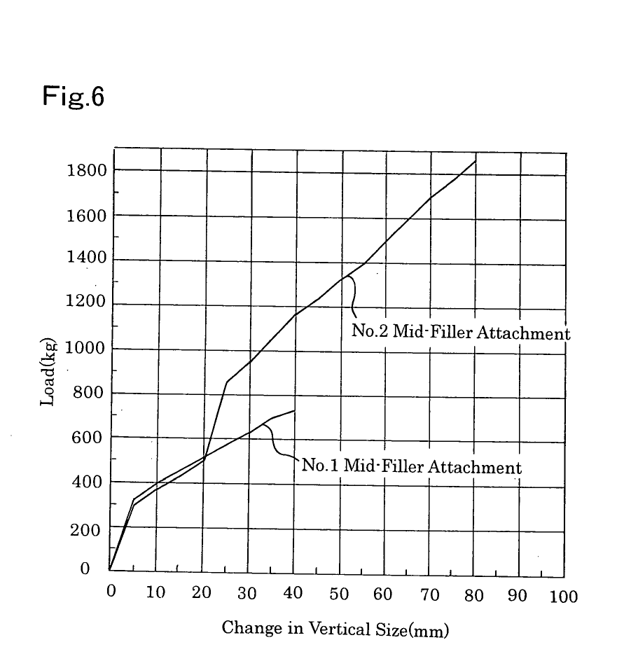

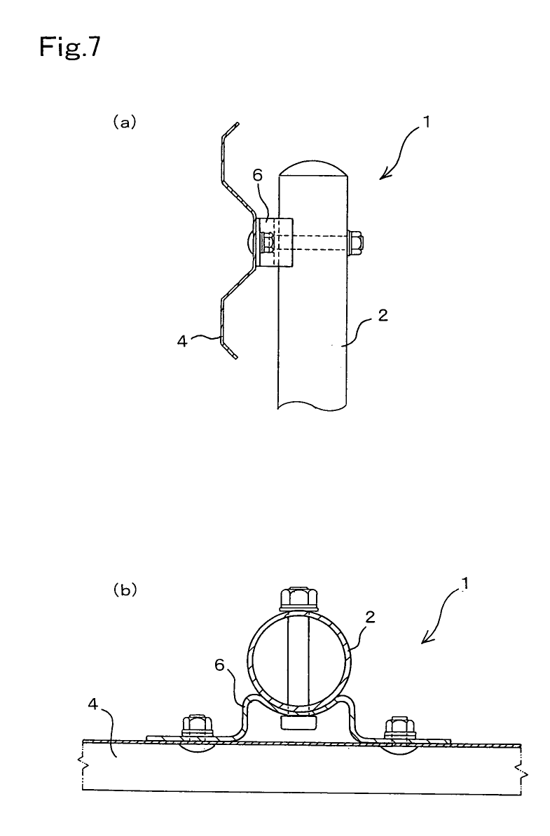

FIG. 6 shows that when a 330 kg load was applied to a mid-filler attachment 26 the change in vertical size reached 5 mm, and when 710 kg load was applied, the change in vertical size reached 40 mm. (A mid-filler attachment 26 can change vertical size only up to about 40 mm.)

When a 500 kg load was applied to the mid-filler attachment 36 the change in vertical size reached 20 mm, and when 865 kg load was applied the change in vertical size reached 25 mm. FIG. 6 shows that a mid-filler attachment 36 is capable of absorbing the collision energy equivalent to a load of 1830 kg.

Materials, size (thickness, width, etc.), shape, and the number of mid-filler attachments used can be varied to optimize the cushioning performance according to the kind of car, collision speed, the car's weight, and so on.

A method of producing a shock-absorbing guardrail comprises the step of providing a guard fence having a back. Attaching a mid-filler attachment to the back of the guard fence.

The method can further comprising the step of attaching the mid-filler attachment to a support post so that the mid-filler attachment is positioned between the back of the guard fence and the support post. The method can further comprise attaching a shock absorbing resin between the back of the guard fence and the support post. The method can also further comprise attaching the mid-filler attachment to a structure so that the mid-filler attachment is positioned between the back of the guard fence and the structure.

The practical examples provided above of the shock-absorbing device described in detailed description is but just a representative example of the possible combinations or assembly of elements disclosed. The examples provided should not be used to limit the usage of the shock-absorbing device. The scope of this invention should be determined by the claims. Therefore, implementation of this invention varies with design change according to the requirements of the specific application.

We claim:

1. A shock-absorbing guardrail comprising:
a guard fence having a back; and,
a mid-filler attachment affixed to the back of the guard fence.

2. The guardrail according to claim 1 further comprising:
at least one arm affixed to the mid-filler attachment; and,
a connector for releasably affixing the arm to the back of the guard fence.

3. The guardrail according to claim 1 further comprising:
a support post affixed to the mid-filler attachment.

4. The guardrail according to claim 3 further comprising:
a shock-absorbing resin positioned between the back of the guard fence and the support post.

5. The guardrail according to claim 3 further comprising:
a shock-absorbing pipe positioned between the guard fence and the support post.

6. The guardrail according to claim 1 wherein the mid-filler attachment has an ohm-shaped cross-section.

7. The guardrail according to claim 1 further comprising:
a large mid-filler attachment; and,
a small mid-filler attachment positioned within the large mid-filler attachment, wherein the mid-filler attachments are affixed to the back of the guard fence.

8. The guardrail according to claim 2 further comprising:
a connector wherein the mid-filler attachment is releasably affixed to the support post with the connector.

9. The guardrail according to claim 1 wherein the mid-filler attachment undergoes irreversible deformation when the guard fence is impacted.

10. The guardrail according to claim 1 further comprising:
a structure selected from the group consisting of support poles, hydrants, semaphoric poles, bifurcations (diverging point), anti-collision sections, sectional walls, walls at parking lots, concrete walls, light pole foundations, and loading docks wherein the structure is affixed to the guard fence with the mid-filler attachment positioned therebetween.

11. The guardrail according to claim 9 further comprising:
a shock-absorbing resin positioned between the guard fence and the structure.

12. The guardrail according to claim 10 further comprising:
a shock-absorbing pipe positioned between the guard fence and the structure.

13. The guardrail according to claim 12 further comprising:
a shock-absorbing resin positioned between the guard fence and the structure.

14. The guardrail according to claim 10 wherein the mid-filler attachment has an ohm-shaped cross-section.

15. The guardrail according to claim 10 wherein the mid-filler attachment has an open pipe shaped cross-section.

16. The guardrail according to claim 10 wherein the mid-filler attachment is affixed to the structure with connection parts.

17. A shock-absorbing guardrail for structures comprising:
a guard fence having a back;
a big mid-filler attachment; and,
a small mid-filler attachment positioned within the big mid-filler attachment, wherein the mid-filler attachments are affixed to the back of the guard fence.

18. The guardrail according to claim 17 wherein the small mid-filler attachment is laminated to the big mid-filler attachment.

19. The guardrail according to claim 17 wherein the big mid-filler attachment and the small mid-filler attachment are arranged in layers.

20. The guardrail according to claim 17 further comprising:
a shock absorbing resin positioned within the mid-filler attachments.

21. The guardrail according to claim 17 further comprising:
a structure selected from the group consisting of support poles, hydrants, semaphoric poles, bifurcations (diverging point), anti-collision sections, sectional walls, walls at parking lots, concrete walls, light pole foundations, and loading docks wherein the structure is affixed to the guard fence with the mid-filler attachments positioned therebetween.

22. The shock-absorbing guardrail of claim 17 further comprising:
a shock-absorbing resin affixed to the back of the guard fence.

23. The shock-absorbing guardrail of claim 17 further comprising:
a shock-absorbing pipe affixed to the back of the guard fence.

24. A method of producing a shock absorbing guardrail comprising:
providing a guard fence having a back;
attaching a mid-filler attachment to the back of the guard fence.

25. The method of claim 24 further comprising:
attaching the mid-filler attachment to a support post so that the mid-filler attachment is positioned between the back of the guard fence and the support post.

26. The method of claim 25 further comprising:
attaching a shock absorbing resin between the back of the guard fence and the support post.

27. The method of claim 24 further comprising:
attaching the mid-filler attachment to a structure so that the mid-filler attachment is positioned between the back of the guard fence and the structure.
